(19) United States
(12) Patent Application Publication
(10) Pub. No.: US 2008/0124542 A1
(43) Pub. Date: May 29, 2008

(54) Nickel Coating

(75) Inventor: Thomas R. Hanlon, Colchester, CT (US)

Correspondence Address: BACHMAN & LAPOINTE, P.C. (P&W), 900 CHAPEL STREET, SUITE 1201, NEW HAVEN, CT, 06510-2802, US

(73) Assignee: UNITED TECHNOLOGIES CORPORATION, Hartford, CT (US)

(21) Appl. No.: 11/944,848

(22) Filed: Nov. 26, 2007

Related U.S. Application Data
(63) Continuation of application No. 11/098,067, filed on Apr. 4, 2005.

(51) Int. Cl. B32B 15/04; B05D 1/36

(52) U.S. Cl. 428/334; 427/404; 428/457

(57) ABSTRACT

A Ni-based first material is deposited on a substrate by electroless plating. A Zn-based second material is deposited on the first material. One or more components of at least one of the first and second materials are diffused into the other. The diffusion creates a ZnNi alloy layer enhancing corrosion resistance.

### CROSS-REFERENCE TO RELATED APPLICATION

This is a continuation application of Ser. No. 11/098,067, filed Apr. 4, 2005, and entitled NICKEL COATING, the disclosure of which is incorporated by reference herein in its entirety as if set forth at length.

### BACKGROUND OF THE INVENTION

The invention relates to nickel coatings. More particularly, the invention relates to electroless nickel boron plating.

U.S. Pat. No. 6,756,134, the disclosure of which is incorporated by reference herein as if set forth at length, discloses a zinc-diffused nickel alloy coating for corrosion and heat protection. Nickel and zinc layers are successively electroplated atop a substrate and then thermally diffused.

Separately, electroless nickel (EN) coatings have been used for purposes including wear and corrosion protection. Electroless nickel phosphorous (ENP or e-NiP) plating may be achieved with use of sodium hypophosphite as a reducing agent. Electroless nickel boron (ENB or e-NiB) plating may be achieved with use of a compound such as sodium borohydride or dimethylaminoborane as the reducing agent. E-NiB coatings may have advantageous wear resistance properties relative to e-NiP coatings, but may not provide advantageous corrosion resistance.

### SUMMARY OF THE INVENTION

A Ni-based first material is applied atop a substrate by electroless plating. A Zn-based second material is applied atop the first material. One or more components of at least one of the first and second materials are diffused into the other. This may create a ZnNi alloy layer enhancing corrosion resistance.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a flow chart of an exemplary coating process.

FIG. 2 is an electron microprobe scan of a cross-section of a two layer Zn atop e-NiB coating on an Fe substrate before diffusion.

FIG. 3 is an enlarged view of the coating of FIG. 2.

FIG. 4 is a view of the coating of FIG. 3 after thermally induced diffusion of the coating layers.

FIG. 5 is a zinc x-ray map of the coating of FIG. 4.

FIG. 6 is a nickel x-ray map of the coating of FIG. 4.

FIG. 7 is a line scan of the coating of FIG. 3, showing Ni, B, and Zn contents.

Like reference numbers and designations in the various drawings indicate like elements.

### DETAILED DESCRIPTION

Corrosion resistance problems of e-NiB coatings are believed due to a micro-porous, columnar structure. To enhance the corrosion resistance it was postulated that a layer of zinc could be applied to the surface of the e-NiB-coated substrate via electroplating, slurry packing, or other method and then interdiffused with the NiB layer.

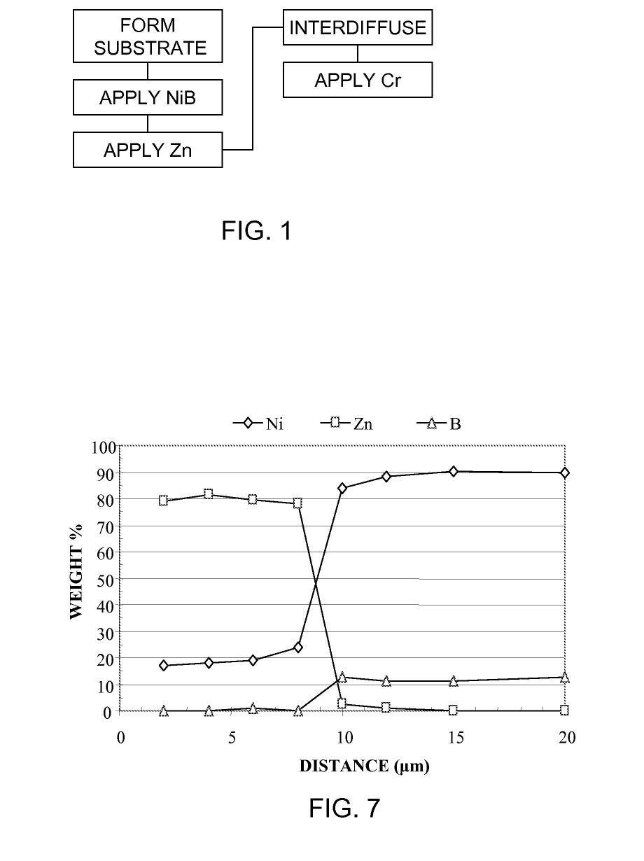

In an illustrative process outlined in FIG. 1, a substrate may be formed. Exemplary substrates are titanium-based (e.g., titanium or a titanium alloy), formed by forging and/or machining. Exemplary substrates are for parts used in the aerospace industry (e.g., gas turbine engine compressor blades, vanes, and other components). After any cleaning or other treatment, a Ni-based first material is applied atop the substrate. The application may be directly atop or one or more intervening layers may have been applied. The application may be to first thickness at a first location. This may be an essentially uniform first thickness over a majority of a surface of the substrate. The first thickness may be substantially less than a local substrate thickness. An exemplary first thickness is at least 5 μm (e.g., 10-1000 μm). This thickness will be purpose dependent. For space-filling (e.g., in dimensional restoration) thicknesses of 500 μm to well in excess of 1000 μm may be appropriate. For wear and corrosion resistance, 10-100 μm may be sufficient. For mere corrosion protection, much thinner coatings are possible. The first material may be NiB and, as applied, may comprise 1-15% B, more narrowly, 1-10%. 1-5% may be appropriate for a low-mid-B coating and/or 9-14% for a high-B coating.

After any cleaning and/or other treatment, a Zn-based second material is applied atop the first material. The application may, preferably, be directly atop or one or more intervening layers may have been applied (if such intermediate layers have sufficient permeability or diffusability to permit diffusion between the first and second materials). The application may be to second thickness at the first location. This may be an essentially uniform second thickness over a majority of a surface of the substrate. The second thickness may be less than the first thickness. An exemplary second thickness is 2-50 μm, more narrowly 5-20 μm.

After any cleaning and/or other treatment, including potential application of one or more additional layers, heating at an appropriate temperature causes one or more components of at least one of the first and/or second materials to diffuse into the other. This diffusion may create a layer of a ZnNi alloy. The heating may be performed in an ambient atmosphere or inert atmospheres. Vacuum or reactive atmospheres are also possible. Exemplary heating is to a temperature of at least 300° C. for a duration of at least half an hour, more specifically 300-500° C. for 0.5-3 hours. The diffusing may be effective to provide a degree of diffusion at least as high as degrees of diffusion obtained by heating to a temperature of 450° C. for a duration of 1.5 hours or 300° C. for two hours.

The diffusion treatment may form an outer/outboard/upper region of essentially 10-25% Ni throughout a depth of at least 50% of said second thickness. The depth may be 100-200% of said second thickness and may span the original junction/boundary between the first and second materials. More broadly, the Zn content may be at least 50% and the Ni content may be at least 10% in the region. The Zn content may be at least 70%.

Inboard/below a shallow transition region, there may be a region of the essentially unchanged first material. For an NiB material, this base region may have an Ni content of at least 50% and a B content of at least 1%. An exemplary thickness is at least 10 μm, although there is substantial potential upside. The Ni content may be at least 80% and the B content may be at least 5% for a mid-high B material. There may be some B diffusion, but the content in the diffused region may be substantially less than that in the base region (e.g., less than one fifth).

There may be further post-diffusion applications or treatments. If to be performed at elevated temperature, there may be an overlap with the diffusion. For example, a Cr-based third material may be applied after at least a major portion of the diffusing or may be applied before. An exemplary finish coating is a Cr-VI- or, more preferably, a Cr-III-based conversion coating applied after the diffusion and serving to further enhance the anti-corrosion properties of the diffused material.

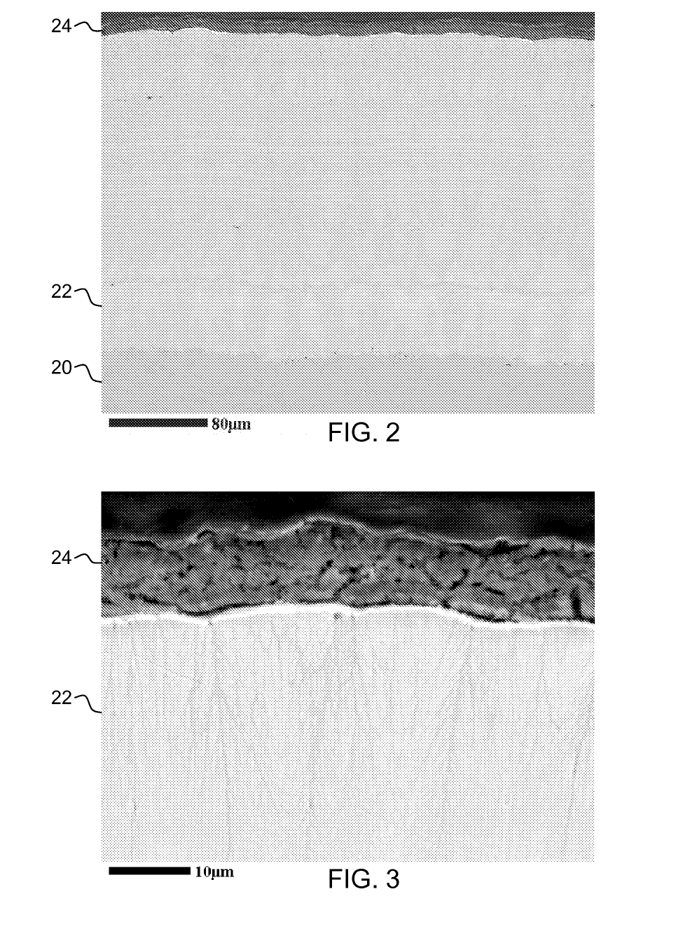

In a test example, only the first and second materials are applied, followed by diffusion and without additional treatments. FIGS. 2 and 3 show a steel test substrate 20 after application of an e-NiB coating 22 and subsequent electroplating with a zinc coating 24. The exemplary NiB coating consists essentially of the nickel and boron and is fairly boron-rich, with a boron content of approximately 10% (all percentages by weight unless indicated otherwise). A thickness of the exemplary coating 22 is about 240 μm. The exemplary zinc coating 24 is electroplated zinc. A thickness of the exemplary coating 24 is about 10 μm.

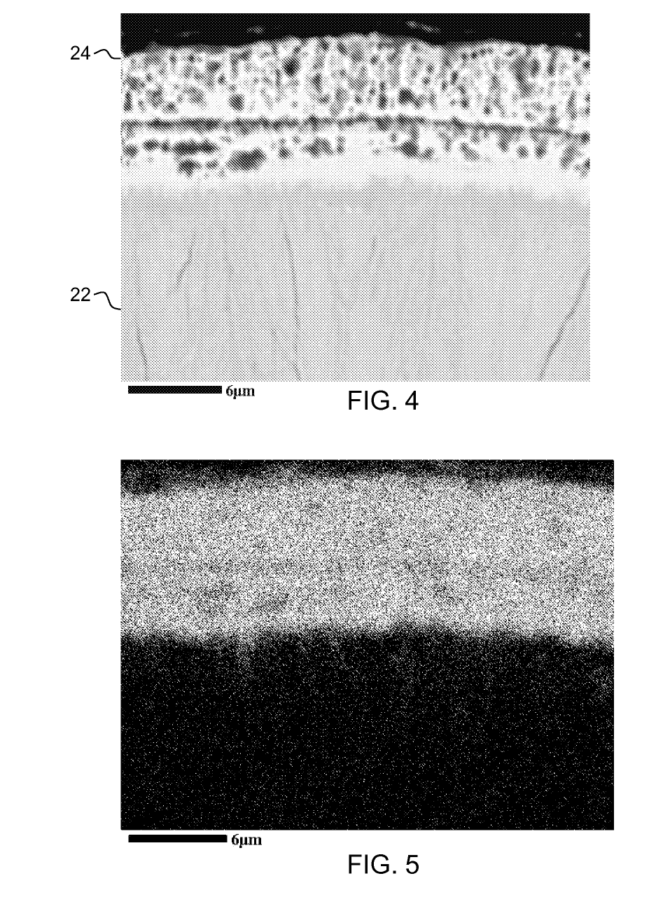

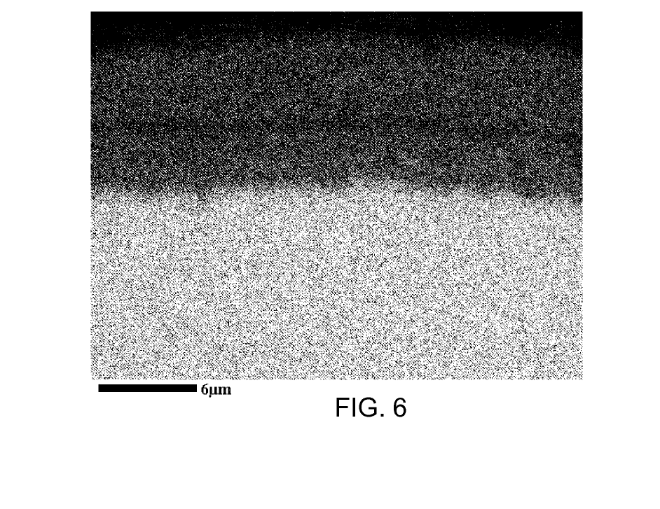

To cause the diffusion, the exemplary substrate was placed in an air oven at 850° F. (454° C.) for two hours. The interdiffused coating is shown in FIG. 4. The original NiB/Zn interface can be seen as a dark line through the lighter colored layer that has dark spots peppered throughout. The interface is similarly visible in the x-ray maps of FIGS. 5 and 6.

FIG. 7 shows line scan data indicating that Zn diffused about 4 μm inward into the e-NiB layer and that Ni, but not B, diffused outward throughout the Zn layer resulting in a layer that is essentially a ZnNi alloy with a near constant 18% Ni by weight. Corrosion resistance is enhanced due to the presence of sacrificial Zn (as ZnNi alloy) at or near (e.g., if a further coating layer is applied) the outer surface of the part. An intermediate transition region is relatively thin. The appearance of concentrations totaling other than 100% is due to sampling considerations and use of raw unnormalized data.

Coating applications include those of existing e-NiB coatings on the one hand and electroplated diffused Ni/Zn coatings (e.g., of U.S. Pat. No. 6,756,134) on the other hand. Relative to the latter, the present coatings' use of e-NiB may offer the advantage of a harder and more highly conformal nickel layer than one obtained by standard electroplating.

One or more embodiments of the present invention have been described. Nevertheless, it will be understood that various modifications may be made without departing from the spirit and scope of the invention. For example, part operating conditions will influence any particular implementation. A wide variety of articles may use the coating and a wide variety of substrate materials may be used. These materials include metals (e.g., Ti-, Fe-, and Al-based) and non-metals (e.g., plastics and composites which may further include a basal metallic coating such as Au to permit overplating with the e-NiB). Accordingly, other embodiments are within the scope of the following claims.

What is claimed is:

1. A method for coating comprising:
applying a Ni-based first material atop a substrate by electroless NiB plating;
applying a Zn-based second material atop the first material; and
diffusing one or more components of at least one of the first and second materials into the other.

2. The method of claim 1 wherein:
the first material is applied directly atop the substrate; and
the second material is applied directly atop the first material.

3. The method of claim 1 wherein:
essentially no additional materials are applied.

4. The method of claim 1 further comprising:
applying a Cr-based third material after at least a major portion of the diffusing.

5. The method of claim 1 further comprising:
applying a Cr-based third material before at least a major portion of the diffusing.

6. The method of claim 1 wherein:
the diffusing comprises heating to a temperature of at least 300° C. for a duration of at least one half hour.

7. The method of claim 1 wherein:
the diffusing comprises heating to a temperature of 300-500° C. for a duration of 0.5-3 hours.

8. The method of claim 1 wherein:
the diffusing is effective to provide a degree of diffusion at least as high as a degree of diffusion obtained by heating to a temperature of 450° C. for a duration of 1.5 hours.

9. The method of claim 1 wherein:
the diffusing is effective to provide a degree of diffusion at least as high as a degree of diffusion obtained by heating to a temperature of 300° C. for a duration of 2.0 hours.

10. The method of claim 1 wherein:
the substrate is Ti-based.

11. The method of claim 1 wherein:
the applying of the first material comprises applying to a first thickness of 50-500 μm at a first location; and
the applying of the second material comprises applying to a second thickness of 5-20 μm at said first location.

12. The method of claim 1 wherein:
the applying of the first material comprises applying to an essentially uniform first thickness; and
the applying of the second material comprises applying to an essentially uniform second thickness less than the first thickness.

13. The method of claim 1 wherein:
the first material, as applied, comprises 1-10% B.

14. The method of claim 1 wherein:
the first material, as applied, comprises 2-6% B.

15. The method of claim 1 wherein:
the diffusing forms a region of essentially 10-25% Ni throughout a depth of at least 50% of said second thickness.

16. A coated substrate formed by the method of claim 1.

17. A method for coating comprising:
applying by electroless NiB plating a Ni-based first material atop a substrate;
applying a Zn-based second material atop the first material; and
a step for forming a NiZn alloy from the first and second materials.

18. The method of claim 17 wherein:
the applying of the first material consists essentially of said electroless plating; and
the step for forming comprises heating to a temperature of at least 400° C. for a duration of at least 1 hour

19. A coated article comprising:
a substrate; and
a coating system having a compositional gradient having:
a first region having:
a Ni content of at least 50%;
a B content of at least 1%; and
a thickness of at least 10 μm; and
a second region outboard of the first region and having:
a Zn content of at least 50%;
a Ni content of at least 10%; and
a thickness of at least 4 μm.

20. The article of claim 19 wherein:
the substrate is Ti-based.

21. The article of claim 19 wherein:
the first region Ni content is at least 80%;
the first region B content is at least 5%;
the second region Zn content is at least 70%;
the second region has a B content less than one fifth of the first region B content; and
the coating system has a transition region between the first and second regions having a thickness of no more than 10 μm.
